(19) United States
(12) Patent Application Publication
(10) Pub. No.: US 2026/0359541 A1
(43) Pub. Date: Nov. 12, 2026

(54) METHOD TO COMPENSATE SUPPLY VOLTAGE FLUCTUATION IN AN INTEGRATED CIRCUIT

(71) Applicant: NVIDIA Corporation, Santa Clara, CA (US)

(72) Inventors: Yuan-Chun Luo, San Jose, CA (US); Pavan Kumar Chundi, San Jose, CA (US); Xianglong Li, Shanghai (CN); Ming-Yen Kao, Santa Clara, CA (US); Chunhui Li, Mountain View, CA (US); Satadru Sarkar, San Diego, CA (US); Sreedhar Pratty, Campbell, CA (US)

(21) Appl. No.: 19/201,444

(22) Filed: May 7, 2025

(51) Int. Cl. G06F 30/367; G06F 30/373; G06F 111/10; G06F 119/10; G06F 119/12

(52) U.S. Cl. CPC G06F 30/367; G06F 30/373; G06F 2111/10; G06F 2119/10; G06F 2119/12

(57) ABSTRACT

A method of designing and manufacturing an integrated circuit (IC), is disclosed. In one embodiment, the method comprises obtaining a nominal delay for each of a plurality of portions of the IC and obtaining a noise spectrum across frequency for a voltage supplied to the IC (V_{DD}). The method further comprises inputting the nominal delay for each of the plurality of portions of the IC and the noise spectrum across frequency for V_{DD} into a physics-based mathematical model where the model generates a statistical standard deviation (σ) for a delay for each of the plurality of portions of the IC at each noise frequency band of the noise spectrum for V_{DD} (delay σ) and the delay σs are combined IC into an overall delay σ. The method further comprises determining a margin of V_{DD} that compensates for the noise spectrum based on the overall delay σ.

### TECHNICAL FIELD

This application is directed, in general, to compensating supply voltage fluctuations in an integrated circuit and, more specifically, to compensate for supply voltage noise in the integrated circuit.

### BACKGROUND

Supply voltage noise, particularly HF noise, adds uncertainty into timing delays of logic paths, degrading integrated circuit (IC) performance and reliability. Voltage for clock tree circuitry on the IC is supplied by the supply voltage and variation of the supply voltage can cause a clock signal for the IC generated by the clock tree circuitry, e.g., the operating frequency of the IC, to speed up or slow down if the variation of the supply voltage, in this case caused by the supply voltage noise, is great enough. Datapaths are also affected by this variation in supply voltage caused by the supply voltage noise. Today's ICs include a large number, e.g., billions, of switching elements, e.g., transistors, and a significant number of these transistors can be switching simultaneously. A large number of transistors switching at the same time is a common cause for the introduction of noise on their supply voltage. These transistors typically switch at very high frequencies. Thus, the noise introduced to the supply voltage due to simultaneous switching of this large number of transistors is typically HF noise (although lower frequency noise can also be introduced on the supply voltage from other means). Of course, there can be other sources of noise that impacts the supply voltage, e.g., thermal. As such, it is important to be able to understand an amount of supply voltage noise that will be present on the IC as it will have an impact on the timing of the IC.

Predicting the timing impact of supply voltage noised can be achieved by the following approaches. One approach to predict the timing impact of supply voltage noise is to assume a constant supply voltage margin across the IC to compensate for the noise effect. However, this constant margin is imprecise and usually unnecessarily pessimistic, which can result in higher power consumption or reliability issues. Another approach to predict the timing impact of supply voltage noise is to model the supply voltage noise, e.g., performing noise-aware SPICE simulations for the supply voltage noise. This approach is more accurate and less pessimistic than the constant margin approach. However, noise-aware SPICE simulations are very time consuming and memory consuming since, if the supply voltage noise is HF noise, the time steps in the SPICE simulation must be very small because of the high frequency nature of the noise and, as such, the time it takes to perform the simulation for so many time steps and the amount of memory needed to perform the simulation is quite high, especially when many cycles of waveforms are to be simulated (for statistical noise analysis). In some cases, it could take 1-2 hours to simulate a short single path on the IC and it could take 1-2 days to simulate longer paths, particularly clock paths. With millions of paths on the IC, this approach is undesirable.

### SUMMARY OF THE DISCLOSURE

In one aspect, a method of designing and manufacturing an integrated circuit (IC), is disclosed. In one embodiment, the method comprises obtaining a nominal delay for each of a plurality of portions of the IC, the nominal delay not including any noise characteristics for each of the plurality of portions of the IC, and obtaining a noise spectrum across frequency for a voltage supplied to the IC (V_{DD}). The method further comprises inputting the nominal delay for each of the plurality of portions of the IC and the noise spectrum across frequency for V_{DD} into a physics-based mathematical model (model) where the model generates a statistical standard deviation (σ) for a delay for each of the plurality of portions of the IC at each noise frequency band of the noise spectrum for V_{DD} (delay σ) and the delay σs are combined into an overall delay σ. The method further comprises determining a margin of V_{DD} that compensates for the noise spectrum based on the overall delay σ and then designing circuitry for the IC based on the V_{DD} margin and manufacturing the IC using the designed circuitry.

In another aspect, a method of testing an integrated circuit (IC) is disclosed. In one embodiment, the method comprises obtaining a nominal delay for each of a plurality of portions of the IC, the nominal delay not including any noise characteristics for each of the plurality of portions of the IC, and obtaining a noise spectrum across frequency for a voltage supplied to the IC (V_{DD}). The method further comprises inputting the nominal delay for each of the plurality of portions of the IC and the noise spectrum across frequency for V_{DD} into a physics-based mathematical model (model) where the model generates a statistical standard deviation (σ) for a delay for each of the plurality of portions of the IC at each noise frequency band of the noise spectrum for V_{DD} (delay σ) and the delay σs are combined IC into an overall delay σ. The method further comprises determining a margin of V_{DD} that compensates for the noise spectrum based on the overall delay σ and then designing circuitry for the IC based on the V_{DD} margin, manufacturing the IC using the designed circuitry, and testing the manufactured IC using a test program based on the V_{DD} margin.

In still another aspect, an integrated circuit is disclosed. In one embodiment, the IC comprises a plurality of circuit blocks including a plurality of portions thereof, wherein a supply voltage (V_{DD}) applied to the plurality of circuit blocks is adjusted to compensate for noise present thereon based on a physics-based mathematical model. In one embodiment, the physics-based mathematical model comprises steps including obtaining a nominal delay for each of a plurality of portions, the nominal delay not including any noise characteristics; obtaining a noise spectrum across frequency for V_{DD}; generating a statistical standard deviation (σ) for a delay for each of the plurality of portions at each noise frequency band of the noise spectrum for V_{DD} (delay σ) based on the nominal delays and noise spectrum; and combining delay σ s for each of the plurality of portions into an overall delay σ.

In yet another aspect, a non-transitory computer-readable storage medium is disclosed. In one embodiment, the non-transitory computer-readable storage medium comprises instructions that, when executed by a processing device, cause the processing device to perform certain operations. In one embodiment, the operations comprise obtaining a nominal delay for each of a plurality of portions of the IC, the nominal delay not including any noise characteristics for each of the plurality of portions of the IC, and obtaining a noise spectrum across frequency for a voltage supplied to the IC (V_{DD}). The operations further comprises inputting the nominal delay for each of the plurality of portions of the IC and the noise spectrum across frequency for V_{DD} into a physics-based mathematical model (model) where the model generates a statistical standard deviation (σ) for a delay for each of the plurality of portions of the IC at each noise frequency band of the noise spectrum for V_{DD} (delay σ) and the delay σs are combined into an overall delay σ. The operations further comprise determining a margin of V_{DD} that compensates for the noise spectrum based on the overall delay σ.

### BRIEF DESCRIPTION OF THE DRAWINGS

Reference is now made to the following descriptions taken in conjunction with the accompanying drawings, in which:

FIG. 1 illustrates a block diagram of an example of an integrated circuit (IC) constructed according to the principles of the disclosure;

FIG. 2 illustrates a flow diagram of an example of a method of compensating for HF supply voltage noise on both datapaths and clock tree circuitry of an IC in the design and manufacture of the IC according to principles of the disclosure;

FIG. 3 illustrates a flow diagram of an example of a method of compensating for HF supply voltage noise on both datapaths and clock tree circuitry of an IC in the design, manufacture, and test of the IC according to principles of the disclosure;

FIG. 4 illustrates a plot of an example of noise voltage on a supply voltage for an IC versus time;

FIG. 5 illustrates a plot of an example of a frequency spectrum of supply voltage noise for an IC;

FIG. 6 illustrates a plot of an example of waveform that is a sine wave representation of one of a plurality of dominant frequencies of supply voltage noise on an IC;

FIG. 7 illustrates a plot of an example of a stage delay σ versus supply voltage noise frequency for that stage derived according to principles of the disclosure; and

FIG. 8 illustrates a plot of an example of a path delay σ versus supply voltage noise frequency for that path with dominant noise frequencies highlighted derived according to principles of the disclosure.

### DETAILED DESCRIPTION OF THE DISCLOSURE

In order to address the above-mentioned problems with supply voltage noise, particularly HF noise, it is desirable to have a fast and accurate method to compensates for supply voltage noise, particularly HF noise, on both datapaths and clock trees in an IC which affect timing of signals in the IC. The datapaths and clock trees of the IC are made up of, in some embodiments, e.g., paths. And the paths, in some embodiments, are made up of, e.g., stages in sequence. And the stages, in some embodiments, are made up of cells, e.g., circuitry. The disclosed method has the following characteristics: 1) a significantly shorter runtime and smaller memory usages than the above-described noise-aware SPICE simulations; 2) is built on a theoretical foundation that can be generalized across technology nodes and processes; and 3) is intuitive so that it can be applied in early-stage IC designs to accelerate IC design cycles.

The method disclosed herein, for example, effectively compensates for HF supply voltage noise while providing an approximately >10⁶ speedup and approximately <0.0001% of memory usage as compared to the above-described noise-aware SPICE simulations. Rather than simulating the HF supply voltage noise, e.g., with SPICE, a physics-based mathematical model is used instead which provides SPICE-level accuracy while requiring very little time per path simulated, e.g., on the order of milliseconds (ms) per path. This physics-based mathematical model uses, in some embodiments, two inputs-nominal timing delays for each stage, e.g., nominal gate-to-gate delays (determined, e.g., from timing reports without noise characteristics for the circuitry in the path) and a noise spectrum for the supply voltage (expressed as, e.g., supply voltage vs. frequency which yields supply a voltage vs. time). Further, just a transition time from, e.g., low to high (or high to low) for the stage, rather than an entire nominal timing delay for the stage, can be used. Moreover, a combination of a nominal delay for a stage (e.g., without noise characteristics) and its transition time can be used. The delays or transition times for the stage can easily be extracted from standard commercial design/timing tools used to design the circuitry in the stages.

The disclosed method is based on a physics-based mathematical model that takes delay and/or transition times of each stage as an input and can provide SPICE level accuracy without needing the time required for performing SPICE simulations. Compared to the above-noted constant margin technique to determine HF supply voltage noise, the disclosed system and method effectively compensates for HF supply voltage noise with a much higher accuracy (typically <1ps of error in the worst case).

The physics-based mathematical model generates a standard deviation (σ) of a timing delay in a path (e.g., a path delay σ) at each frequency band of supply voltage noise for each stage in a path and can do so for all frequencies of signals used in the path. The overall path delay σ is subsequently translated to a voltage output margin required to compensate for the HF noise on the supply voltage. Because the physics-based mathematical model can generate the path delay σ for all frequencies of noise, it can be used to model not only HF supply voltage noise, but also lower frequency supply voltage noise. And further, the physics-based mathematical model can be used to model noise, HF and otherwise, on ground (GND) signals, rather than supply voltage, as well.

In some embodiments, rather than generating a path delay σ for each path, a cell delay σ for each cell in the path can be generated by the physics-based mathematical model with, rather than a noise spectrum for the supply voltage to the path, a noise spectrum for the supply voltage to the cell and a delay for each cell. Further, a stage delay σ can be generated by the physics-based mathematical model with a noise spectrum for the supply voltage to the stage and a delay for each stage. These various noise spectrums for the supply voltages, e.g., for the path, cell, or stage, can be determined by measurement or from simulation. As disclosed above, the delays input into the physics-based mathematical model, e.g., for the path, cell, or stage, can be nominal delays for the path, cell, or stage without noise characteristics for circuitry in the path, cell, or stage.

The path delay σ can be used for several things. This path delay σ can be directly applied to determine a delay margin for the datapath as well as to determine timing uncertainties for each path (both datapaths and clock paths) in the IC. Further, at a same time, the path delay σ can be used to update a new operating frequency of the IC, e.g., fₘₐₓ. Then the new operating frequency can be used to map to a new supply voltage V_{DD} that compensates for the noise on the supply voltage.

In some embodiments, a path in the IC that is modeled to have the highest susceptibility to HF supply voltage noise, i.e., the path with the highest path delay σ, is identified and circuit designers can then take steps to reduce the path delay σ for this highest path delay σ. This reduces the overall susceptibility for HF supply voltage noise on the IC. These steps can be performed iteratively, e.g., after the path with the highest path delay σ is corrected, then the path with the next highest path delay σ is corrected, and so on.

After IC circuit design, a path in the IC circuit with the highest path delay σ can be identified from the physic-based mathematical model. Once an IC has been fabricated with the circuit design, a test program for the fabricated IC can prioritize testing for the identified path with the highest path delay σ, thereby shortening the development cycle of the IC, i.e., accelerating the product testing phase of the IC development. Furthermore, it is difficult to simulate HF supply voltage noise effects on process variation for the same reason it is difficult to perform noise-aware SPICE simulations—there are hundreds of process parameters that need to be considered when simulating HF supply voltage noise effects on process variation. But, as with the above-disclosed technique to compensate for HF supply voltage noise, the physics-based mathematical model can be used to analyze the combined effect of HF supply voltage noise and process variation much, much faster and more accurately.

In some embodiments, the disclosed method is embodied on a non-transitory computer-readable medium that comprises instructions that cause a processing device, e.g., a computer, to perform the operations disclosed above.

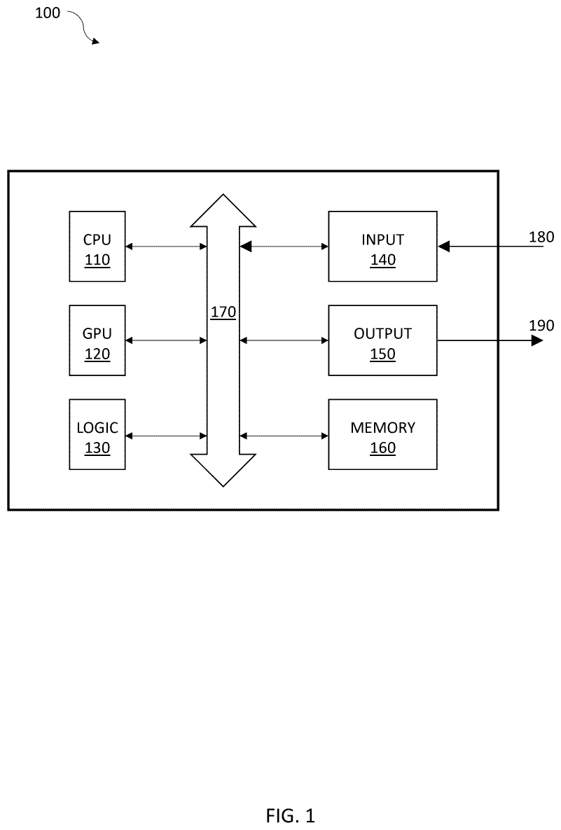

Referring to the drawings, specifically FIG. 1, a block diagram of an example of an integrated circuit (IC) 100 is illustrated that is constructed according to the principles of the disclosure is shown. IC 100 includes at least one CPU 110, at least one GPU 120, at least one logic block 130, input circuitry 140, output circuitry 150, and memory 160. Of course, in some embodiments IC 100 can include more than one CPU 110, GPU 120, or logic blocks 130 or, in other embodiments, IC 100 could omit any of CPU 110, GPU 120, or logic block 130. As depicted in FIG. 1, in some embodiments, CPU 110, GPU 120, logic block 130, input circuitry 140, output circuitry 150, and memory 160 communicate with each other over bus 170. In some embodiments, additional busses between different processing units (e.g., CPU 110, GPU 120) and between different processing units (e.g., CPU 110, GPU 120), logic block 130, input circuitry 140, output circuitry 150, and memory 160 can be employed (not shown). Memory 160 can be comprised of differing types of volatile memories (e.g., dynamic random access (DRAM) memory, SRAM memory, etc.) and/or non-volatile memories (e.g., read-only memory (ROM), erasable programmable read-only memory (EPROM), electrically erasable programmable read-only memory (EEPROM), flash memory, etc.). In some embodiments of IC 100, memory 160 includes on-chip SRAM which includes a writability monitoring circuit constructed in accordance with the principles of the disclosure as described below. Also as depicted in FIG. 1, IC 100's input circuitry 140 accepts signals 180 externally provided to IC 100 and IC 100's output circuitry 150 provides signals 190 external to IC 100.

The above-disclosed circuitry on the IC that uses the supply voltage margin generated by the path delay σ disclosed below can be any circuitry on the IC. For example, any or all of the circuitry blocks of IC 100 of FIG. 1 discussed above would be subject to the supply voltage margin generated by the path delay σ disclosed below.

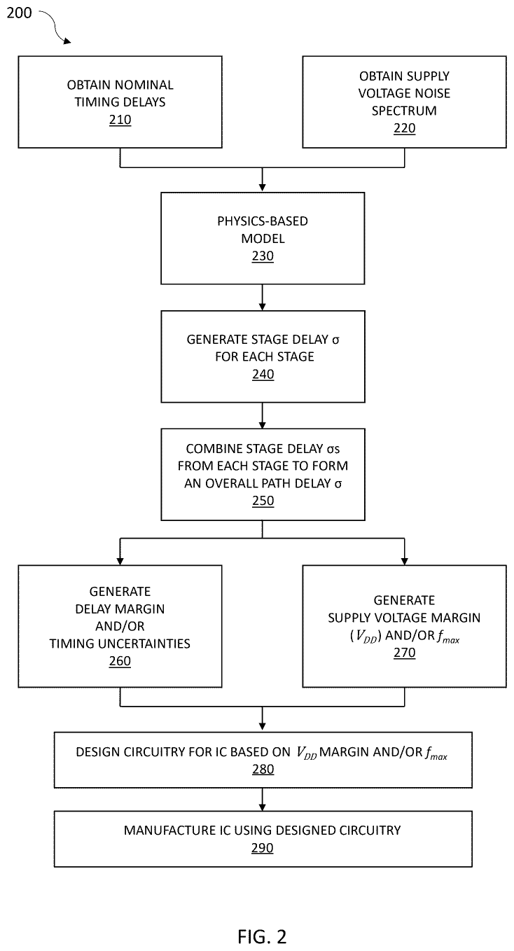

FIG. 2 illustrates a flow diagram of an example of method 200 of compensating for HF supply voltage noise on both datapaths and clock tree circuitry of an IC in the design and manufacture of the IC according to principles of the disclosure. Method 200 can be executed by one or more processors according to instructions corresponding to one or more algorithms directed to compensating for supply voltage noise, such as HF supply voltage noise. At step 210 nominal timing delays for each cell (e.g., circuitry) in a stage of a path in the IC are obtained. These timing delays (e.g., gate-to-gate delays) can be obtained from commercial electronic design automation (EDA) tools used for circuit design and physical design (e.g., PrimeTime, Tempus, Verilog, as well as SPICE). In some embodiments, these timing delays for the cell are for a time when the output voltage of the cell reaches 50% of the supply voltage (e.g., V_{DD}) minus the time when an input voltage of the cell reaches 50% of the supply voltage. As discussed above, these nominal timing delays are based on voltages without noise characteristics.

At step 220 a noise spectrum for the supply voltage to the IC (or ground) is obtained. In some embodiments, the noise spectrum is portrayed as a waveform, e.g., noise voltage vs. time or translated and portrayed as a spectrum, e.g., noise voltage vs. frequency. The V_{DD}/GND noise waveforms are transient signals for signals, e.g., V_{DD} or GND, applied to the cell. The voltage variations of V_{DD}/GND noise are the result of both low-frequency and high-frequency effects (e.g., as described above), including an effect of physical noise (e.g., thermal noise, flicker noise, and shot noise) as well as design/workload-related noises including lower-frequency noises induced by parasitics at a package level and higher-frequency noises induced by circuitry switching due to different workloads/excitations as described above. The resulting transient voltage waveforms at V_{DD}/GND can be obtained by commercial EDA tools using numerical solvers, e.g., Redhawk-SC™ available from Ansys of Canonsburg, PA, or any SPICE tools. In some embodiments, the resulting transient voltage waveforms can be obtained empirically from testing measurements of an IC for future IC designs using similar process technologies.

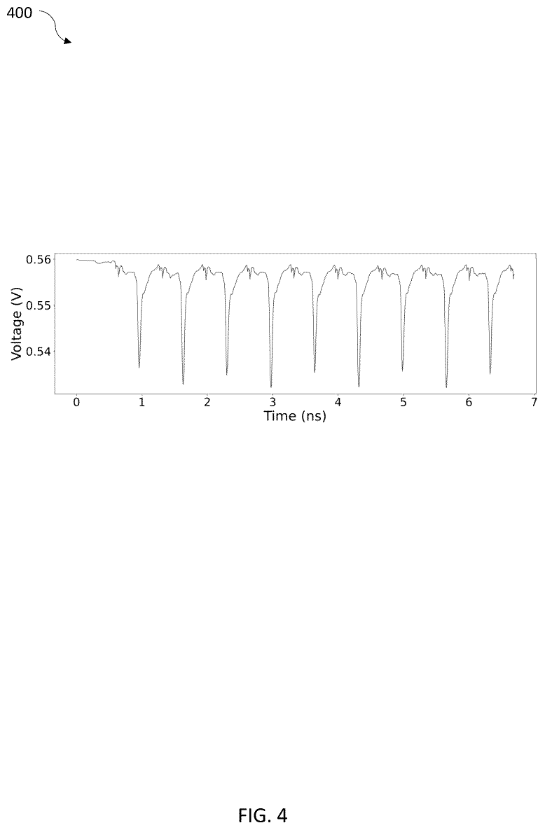

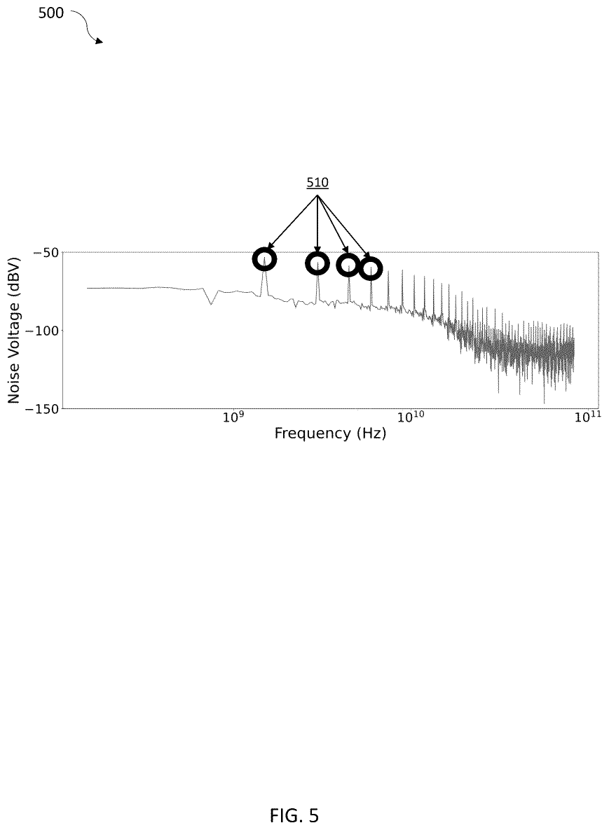

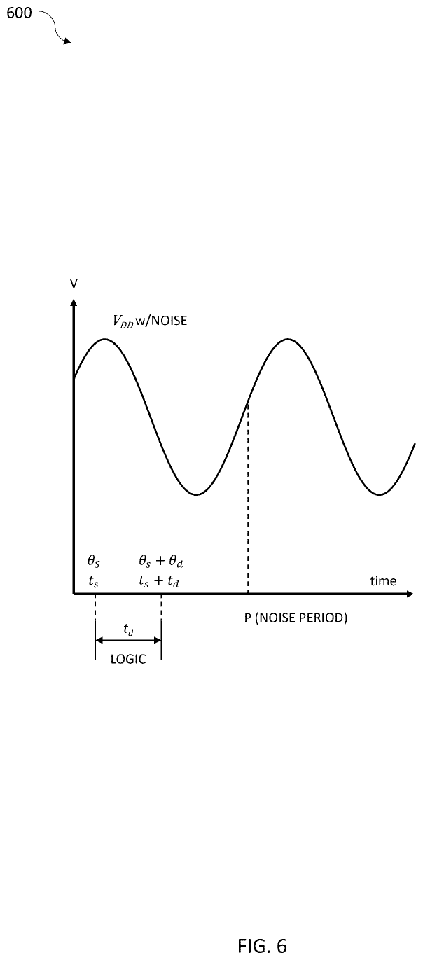

Step 230 involves applying the obtained nominal timing delays from step 210 and obtained supply voltage noise spectrum from step 220 to a physics-based mathematical model as disclosed below. Example waveforms 400 and 500 help describe this physics-based mathematical model used in step 230. FIG. 4 illustrates a plot of a waveform 400 of supply voltage (e.g., V_{DD}) noise over time as input to the physics-based mathematical model (e.g., step 220/320 in FIGS. 2/3 disclosed above). Waveform 400 is a combination of a plurality of sine waves at individual supply noise voltage noise frequencies, one of which will be used below in FIG. 6 to disclose how a path delay σ is generated by the physics-based mathematical model. FIG. 5 illustrates a plot of a frequency spectrum 500 of the supply voltage noise of, e.g., waveform 400 of the same supply voltage noise over time. (In some embodiments, frequency spectrum 500 is a Laplace transform of the supply voltage noise over time shown, e.g., in waveform 400 in FIG. 4.) Peaks 510 of frequency spectrum 500 of the supply voltage noise show the dominant frequencies of the supply voltage noise in a particular stage. FIG. 5 depicts four peaks 510 are selected for analysis. However, more or fewer peaks could be selected for analysis or, in the alternative, every other peak could be used for analysis, or every third peak, etc. The number of peaks selected for analysis can be user-defined.

FIG. 6 illustrates a plot of waveform 600. Waveform 600 is a sine wave representation of one of a plurality of sine waves that make up the supply voltage noise shown, e.g., in waveform 400 of FIG. 4 as disclosed above. Waveform 600 is a sine wave representative of one of the dominant frequencies of noise on the supply voltage from the supply voltage noise spectrum obtained in step 220 at one stage of a path as shown as one of selected peaks 510 in waveform 500 in FIG. 5 disclosed above. As disclosed below, the physics-based mathematical model of step 230 generates a path delay σ for each dominant supply voltage noise frequency for one stage of the path. Path delay σs for each dominant supply voltage noise frequency for a stage of a path generated by the physics-based mathematical model are then used in step 240 to generate the stage delay σ for the one stage of the path.

There are two steps to the physics-based mathematical model. The first step of the physics-based mathematical model involves deriving a Δ delay for the stage/cell as shown in equations 1-3 below:

$$\begin{matrix}Δ delay & = & a {\int }_{t = {t}_{s}}^{t = {t}_{s} + {t}_{d}} - sin ( t ) dt & ( 1 ) \\ & = & \frac{aP}{2 π} {\int }_{θ = {θ}_{s}}^{θ = {θ}_{s} + {θ}_{d}} - sin θ d θ & ( 2 ) \\ & = & \frac{aP}{2 π} ( - cos ( {θ}_{s} + {θ}_{d} ) + cos ( {θ}_{s} ) ) & ( 3 )\end{matrix}$$

$$( assume Δ {V}_{DD} ∝ Δ I ∝ - Δ delay )$$

where a is the supply voltage noise amplitude (AVDD) normalized to the nominal supply voltage V_{DD} (Vₙₒₘᵢₙₐₗ),

$$e . g . , a = \frac{Δ {V}_{D D}}{{V}_{nominal}} ,$$

P is the time period of the noise (or the inverse of the noise frequency,

$$e . g , \frac{1}{{f}_{noise}} ) ,$$

tₛ=start of a time window in which the path or stage delay is under the influence of the supply voltage noise, t_{d}=a length of the time window where the path or stage delay is under the influence of the supply voltage noise, e.g., delay time, θ=supply voltage noise phase, θₛ=supply voltage noise phase at the start of the time window, and θ_{d}=supply voltage noise phase change from the start to the end of the time window.

The second step of the physics-based mathematical model involves calculating a stage/cell delay σ² for any θₛ as shown in equations 4-6 below:

$$\begin{matrix}Delay ( {σ}^{2} ) : fp ( {t}_{d} ) & = & \frac{1}{2 π} {\int }_{{θ}_{s} = 0}^{{θ}_{s} = 2 π} {( \frac{aP}{2 π} ( cos ( {θ}_{s} ) - cos ( {θ}_{s} + {θ}_{d} ) ) )}^{2} d {θ}_{s} & ( 4 ) \\ & = & \frac{{( aP )}^{2}}{4 {π}^{2}} ( 1 - cos ( {θ}_{d} ) ) & ( 5 ) \\ & = & \frac{{aP}^{2}}{4 {π}^{2}} ( 1 - cos ( \frac{2 π {t}_{d}}{P} ) ) & ( 6 )\end{matrix}$$

Thus, a stage/cell timing delay σ² reflective of supply voltage noise can be derived from a normalized noise voltage amplitude (a), a time period of the noise (P), and a time delay window where the supply voltage noise is measured (ta). Since a is a normalized supply voltage noise amplitude, a weights the stage delay σ² (and each path delay σ) for each dominant frequency of supply voltage noise based on its amplitude. These weighted stage delay σ²s for each dominant frequency of supply voltage noise are then directly summed to generate the stage delay σ in step 240. Thus, the generation of the stage delay σ in step 240 is a weighted superposition of the stage delay σs for each dominant supply voltage noise frequency. σ² stage delays are generated using equations (1)-(6) for each stage in a path.

In step 250 the stage delay σ (from the stage delay σ² of equation (6) above) for each given path is combined into an overall path delay σ. When the supply voltage noise spectrums for each stage in a path areindependent, the overall path delay σ generated in step 250 is simply the square root of a direct summation of all of the stage delay σ²s (generated by equation (6) above). When the supply voltage noise spectrums are dependent for the stages in the path, the overall path delay σ generated in step 250 is the square root of function of all of the stage delay σ²s (generated by equation (6) above) based on correlations among supply voltage noise spectrums for all stages.

As disclosed below, step 260 generates a delay margin and/or timing uncertainties. Also as disclosed below, step 270 generates a supply voltage margin (V_{DD}) and/or fₘₐₓ for the IC. At step 280, circuitry for the IC is designed based on the generated supply voltage margin and/or fₘₐₓ. At step 290, the IC is manufactured using the designed circuitry from step 280.

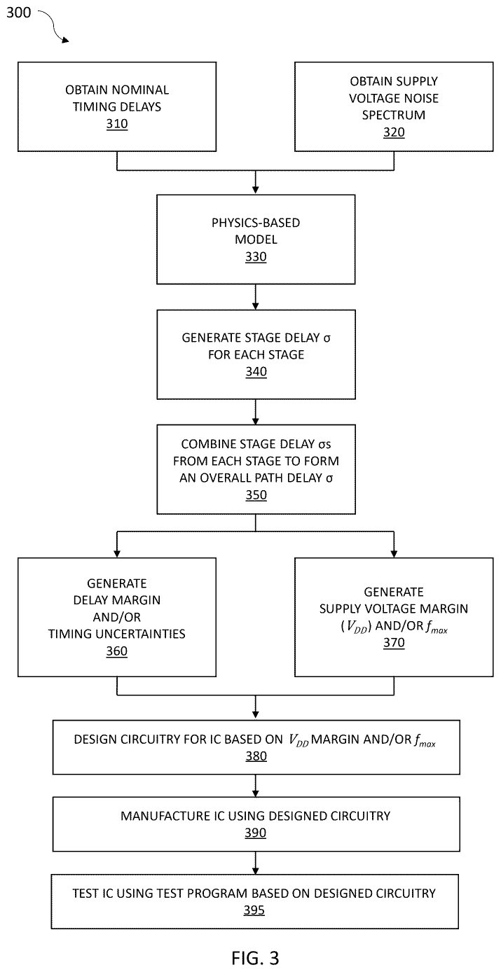

FIG. 3 illustrates a flow diagram of an example of a method 300 of compensating for HF supply voltage noise on both datapaths and clock tree circuitry of an IC in the design, manufacture, and test of the IC according to principles of the disclosure. Method 300 can be executed by one or more processors according to instructions corresponding to one or more algorithms directed to compensate for supply voltage noise, such as HF supply voltage noise. Similar to step 210 in FIG. 2, nominal timing delays for each cell (e.g., circuitry) in a stage of a path in the IC are obtained at step 310. As discussed above, these nominal timing delays are based on voltages without noise characteristics.

Similar to step 220 in FIG. 2, a noise spectrum for the supply voltage (or ground) to the IC is obtained at step 320. Similar to step 230 of FIG. 2, step 330 involves using the obtained nominal timing delays from step 310 and obtained supply voltage noise spectrum from step 320 applied to a physics-based mathematical model disclosed above.

The physics-based mathematical model of step 330 outputs a stage delay σ for any given stage/cell in step 340. Similar to step 250 in FIG. 2, the stage delay σs for each given stage/cell are combined in step 350. As disclosed below and similar to step 260 of FIG. 2, step 360 generates a delay margin and/or timing uncertainties. Also as disclosed below and similar to step 270 of FIG. 2, step 370 generates a supply voltage margin (V_{DD}) and/or fₘₐₓ for the IC. Similar to step 280, circuitry for the IC is designed based on the generated supply voltage margin and/or fₘₐₓ at step 380. Similar to step 290 in FIG. 3, the IC is manufactured using the designed circuitry from step 380 in step 390. At step 395, the IC manufactured in step 390 is tested using a test program based on the designed circuitry of step 395.

In some embodiments, after the IC circuit design in step 380, a path in the IC with the highest path delay σ generated in step 350 can be identified from the physics-based mathematical model (of step 330). Once the IC has been manufactured in step 390, the test program of step 395 for the IC can prioritize testing for the identified path with the highest path delay σ, thereby shortening the development cycle of the IC, i.e., accelerating the product testing phase of the IC development.

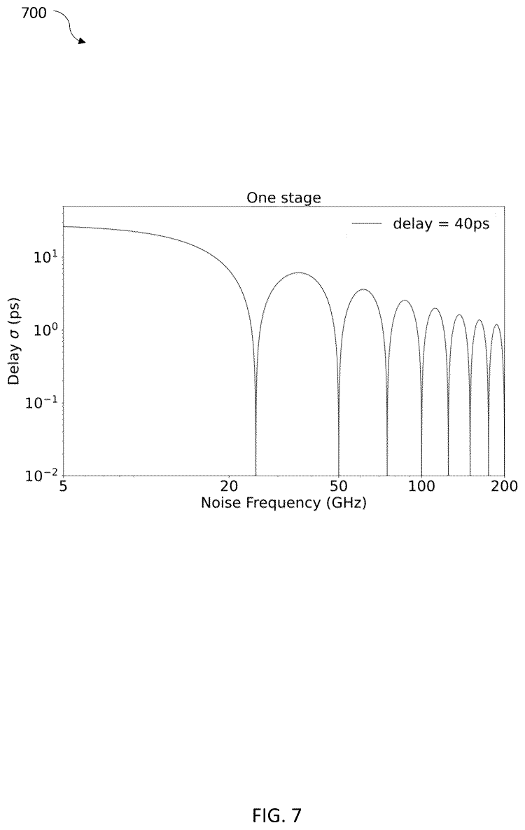

FIG. 7 illustrates a stage delay σ plot 700 for a stage delay σ versus supply voltage noise frequency for that stage derived from the above equations for, e.g., one stage of a path (or it could be for one cell also), e.g., from step 240 of FIG. 2.

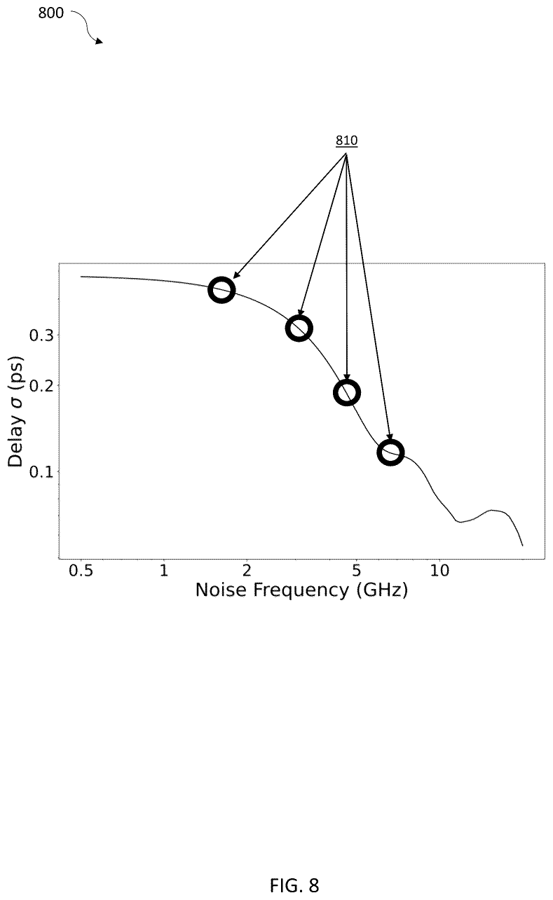

FIG. 8 illustrates a plot 800 of a path delay σ versus supply voltage noise frequency for a path from the stages that make up the path. The path σ is generated as disclosed above. The dominant supply voltage frequencies (e.g., from peaks 510 in FIG. 5) are translated back onto path delay σ plot 800 and shown as peaks 910.

These path delay σs are then used for many things. For example, the path delay σs can be used to set the overall supply voltage margin, e.g., V_{DD} margin, for the IC that includes the paths. In some embodiments, an overall supply voltage margin comprehending the supply voltage noise can be based on the path with the highest path delay σ. Additionally, the overall supply voltage margin determined for the IC can be used, in some embodiments, to set a new (reduced) operating frequency for the IC, e.g., fₘₐₓ, that accounts for the supply voltage less the supply voltage margin. That is, the supply voltage margin determined from the path delay σ, e.g., in some embodiments from the highest path delay σ, is subtracted from the nominal supply voltage and then used to calculate a new, lower, operating frequency for the IC so that there is less chance the IC will have operating issues when in use due to supply voltage noise (high frequency noise or otherwise).

Further, the path delay σs can be used to set delay margins for the IC or set a clock uncertainties for the IC. Many commercial EDA tools can then take the delay margins and/or clock uncertainties as part of input parameters to calculate a corresponding path timing slack under supply voltages noises. Yet even further, the path delay σ can be used when developing testing strategies for the IC. In this case, paths with higher delay σs can be identified as these paths will be more susceptible to supply voltage noise and then testing for those paths with higher os can be prioritized and improved. This can shorten the overall time to design the IC and to test the IC.

When designing the IC, paths with higher delay σs can be identified for design modifications that will improve a respective path delay σ so that that path is less susceptible to supply voltage noise. This process can be iterative in that the IC design where, e.g., a path with the highest σ can be optimized to improve its respective path delay σ and then a path with the next highest delay σ can be identified and its designed optimized to improve its path delay σ as well, and so on. The net effect being that the entire IC can be optimized so that it is less susceptible to supply voltage noise and, as a result, the supply voltage noise margin would need to be smaller improving the operation of the IC, e.g., increasing the operating frequency of the IC.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with the digital data processors or computers.

The digital data processors or computers can be comprised of one or more GPUs, one or more CPUs, one or more of other processor types, or a combination thereof. The digital data processors and computers can be located proximate each other, proximate a user, in a cloud environment, a data center, or located in a combination thereof. For example, some components can be located proximate the user and some components can be located in a cloud environment or data center.

The GPUs can be embodied on a single semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on a single chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic and/or features for performing a task or tasks. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method of designing and manufacturing an integrated circuit (IC), the method comprising:
obtaining a nominal delay for each of a plurality of portions of the IC, the nominal delay not including any noise characteristics for each of the plurality of portions of the IC;
obtaining a noise spectrum across frequency for a voltage supplied to the IC (V_{DD});
inputting the nominal delay for each of the plurality of portions of the IC and the noise spectrum across frequency for V_{DD} into a physics-based mathematical model (model);
generating, by the model, a statistical standard deviation (σ) for a delay for each of the plurality of portions of the IC at each noise frequency band of the noise spectrum for V_{DD} (delay σ);
combining delay σs for each of the plurality of portions of the IC into an overall delay σ;
determining a margin of V_{DD} that compensates for the noise spectrum based on the overall delay σ;
designing circuitry for the IC based on the V_{DD} margin; and
manufacturing the IC using the designed circuitry.

2. The method as recited in claim 1, wherein the portions of the IC is a stage or a cell of the IC.

3. The method as recited in claim 1, wherein the plurality of portions of the IC are a datapath of the IC.

4. The method as recited in claim 3, wherein the delay σ for each of the plurality of portions of the IC is directly applied to determine a timing uncertainty for each of the plurality of portions of the IC.

5. The method as recited in claim 1, wherein the plurality of portions of the IC are a clock tree of the IC.

6. The method as recited in claim 5, wherein the delay σ for each of the plurality of portions of the IC is directly applied to determine a timing uncertainty for each of the plurality of portions of the IC.

7. The method as recited in claim 1, wherein the combining of the delay σs for each of the plurality of portions of the IC is obtained by a weighted superposition of the delay σs for different frequency bands of the noise spectrum.

8. The method as recited in claim 1, wherein the overall delay σ is used to update a new maximum operating frequency for the IC (fₘₐₓ).

9. The method as recited in claim 1, wherein the delay σ for each of the plurality of portions of the IC is directly applied to determine a delay margin for each of the plurality of portions of the IC.

10. The method as recited in claim 1, wherein a transition time for each of the portions of the IC is used in combination with the nominal delay for each of the plurality of portions of the IC.

11. The method as recited in claim 10, wherein the transition time is selected from the group consisting of a low-to-high transition time and a high-to-low transition time.

12. A method of testing an integrated circuit (IC), the method comprising:
obtaining a nominal delay for each of a plurality of portions of the IC, the nominal delay not including any noise characteristics for the portion of the IC;
obtaining a noise spectrum across frequency for a voltage supplied to the IC (V_{DD});
inputting the nominal delay for each of the plurality of portions of the IC and the noise spectrum across frequency for V_{DD} into a physics-based mathematical model (model);
generating, by the model, a statistical standard deviation (σ) for a delay of each of the plurality of portions of the IC at each noise frequency band of the noise spectrum for V_{DD} (delay σ);
combining delay σs for each of the plurality of portions of the IC into an overall delay σ;
determining a margin of V_{DD} that compensates for the noise spectrum based on the overall delay σ;
designing circuitry for the IC based on the V_{DD} margin;
manufacturing the IC using the designed circuitry; and
testing the manufactured IC using a test program based on the V_{DD} margin.

13. The method as recited in claim 12, wherein the portions of the IC is stage or a cell of the IC.

14. The method as recited in claim 12, wherein the plurality of portions of the IC are a datapath of the IC.

15. The method as recited in claim 12, wherein the plurality of portions of the IC are a clock tree of the IC.

16. The method as recited in claim 12, wherein the test program prioritizes portions of the IC with a highest delay σ.

17. An integrated circuit (IC), comprising:
a plurality of circuit blocks including a plurality of portions thereof, wherein a supply voltage (V_{DD}) applied to the plurality of circuit blocks is adjusted to compensate for noise present thereon based on a physics-based mathematical model, the physics-based mathematical model comprising steps including:
obtaining a nominal delay for each of a plurality of portions, the nominal delay not including any noise characteristics;
obtaining a noise spectrum across frequency for V_{DD};
generating a statistical standard deviation (σ) for a delay for each of the plurality of portions at each noise frequency band of the noise spectrum for V_{DD} (delay σ) based on the nominal delays and noise spectrum; and
combining delay σs for each of the plurality of portions into an overall delay σ.

18. The IC as recited in claim 17, wherein the overall delay σ can be directly applied to determine a delay margin and timing uncertainties for each of the plurality of portions of the IC.

19. A non-transitory computer-readable storage medium comprising instructions that, when executed by a processing device, cause the processing device to perform operations comprising:
obtaining a nominal delay for each of a plurality of portions of the IC, the nominal delay not including any noise characteristics for each of the plurality of portions of the IC;
obtaining a noise spectrum across frequency for a voltage supplied to the IC (V_{DD});
inputting the nominal delay for each of the plurality of portions of the IC and the noise spectrum across frequency for V_{DD} into a physics-based mathematical model (model);
generating, by the model, a statistical standard deviation (σ) for a delay for each of the plurality of portions of the IC at each noise frequency band of the noise spectrum for V_{DD} (delay σ);
combining delay σs for each of the plurality of portions the IC into an overall delay σ; and
determining a margin of V_{DD} that compensates for the noise spectrum based on the overall delay σ.
